(19) United States
(12) Patent Application Publication
(10) Pub. No.: US 2016/0078774 A1
(43) Pub. Date: Mar. 17, 2016

(54) SYSTEM AND METHOD FOR PROVIDING PERSONALITY ANALYSIS

(71) Applicant: Conceep Ltd., Ramat Gan (IL)

(72) Inventor: Igal VARDI, Givatayim (IL)

(21) Appl. No.: 14/820,734

(22) Filed: Aug. 7, 2015

Related U.S. Application Data
(60) Provisional application No. 62/051,338, filed on Sep. 17, 2014.

(51) Int. Cl. G09B 7/06

(52) U.S. Cl. CPC G09B 7/06

(57) ABSTRACT

A method for automatically analyzing personality is presented, the method comprising presenting to an examinee a Yes/No type question related to a characterizing value. The characterizing value is selected from a set of N characterizing values which is formed uniquely for the examinee. The method also comprises receiving from the examinee a Yes or No response, recording the response with its respective characterizing value, enabling the examinee to re-answer a question when the examinee wishes to re-answer it, repeating previous steps until questions related to all of the M characterizing values are answered and the responses are recorded. Finally, integrating the answers to the M characterizing values while considering the effect of scores of certain responses on the scores of certain other responses associated with cross-related characterizing values, and processing the integrated answers and providing a personality report.

### CROSS REFERENCE TO RELATED APPLICATIONS

This application claims the benefit of U.S. Provisional Patent Application No. 62/051,338, filed Sep. 17, 2014, which is hereby incorporated by reference in its entirety.

### BACKGROUND OF THE INVENTION

Methods of analyzing personality features and characteristics of an examinee or a candidate for a position, based on analysis of the examinee's response to set/s of questions presented to him are known in the art. For example personality analysis methods such as Myers-Briggs, Big Five, Eysenck EPQ, 16PF, MMPI and Enneagram present sets of questions to the examinee and expect him/her to answer by selecting a grade from a range of grades, for example selecting one grade or level among 5 possible levels, that best fits the position of the examinee in his answer. Methods known in the art suffer from several drawbacks, as described below.

Most of the questions presented to the candidate/examinee require the examinee to adapt a certain grade from a scale of grades (e.g., select the number that best presents the examinee's evaluation of the respective issue presented as a question between, for example, 1-7 grades (high number represents high evaluation)). This way of extracting the examinee's position towards the value of a variable/feature forces the examinee to accord numeric value to non-numeric entities. It is known in the art that the selection of most examinees will concentrate in a narrow range of numbers around the mid-high value (e.g., between 4 and 6, or around 5, in the example above), thus practically deteriorating the value of a larger scale of grades and distorting the authenticity of the response.

The need to accord a numeric value to non-numeric entities is a burden that typically exhausts the examinee and causes degradation in his/her concentration during the period of examination.

According of a numeric value to non-numeric entities may cause deflection in the analyzed results due to inherent inconsistency in the accorded numeric values.

Analysis of the examinee's responses needs at least partial involvement of a professional in processing and providing of personality analysis.

### SUMMARY OF THE INVENTION

A method for automatically analyzing personality is presented, the method comprising presenting to an examinee a Yes/No type question related to a characterizing value, wherein said characterizing value is selected from a set of N characterizing values formed uniquely for the examinee; receiving from said examinee a Yes or No response; recording said response with its respective characterizing value; allowing said examinee to re-answer said question when said examinee wishes to re-answer said question; repeating previous steps until questions related to all of the M characterizing values are answered and the responses are recorded; integrating the answers to said M characterizing values while considering the effect of scores of certain responses on the scores of certain other responses associated with cross-related characterizing values: and processing said integrated answers and providing a personality report.

According to some embodiments, the value of M is 90.

According to some embodiments, the examinee's Yes or No response indicates whether the characterizing value presented to the examinee characterizes the examinee.

According to some embodiments, the step of recording comprises recording of the time period lapsing from the minute the characterizing value was presented to the examinee and the time the examinee has provided an answer.

According to some embodiments, the step of recording comprises recording how many times the examinee responded to that characterizing value question.

A system for automatically analyzing personality is presented comprising a workstation comprising a storage unit and a communication interface for rambling communication between the workstation, a mass storage unit, and a large area network; a mass storage unit for storing large collections of characterizing values and data representing crowd averages; a large area network and an input/output unit for presenting instructions, data and questions to an examinee and for receiving input indications from said examinee. The workstation is configured to present to an examinee a Yes/No type question related to a characterizing value, wherein said characterizing value is selected from a set of N characterizing values formed uniquely for the examinee, receive from said examinee a Yes or No response, record said response with its respective characterizing value, allow said examinee to re-answer said question when said examinee wishes to re-answer said question, repeat previous steps until questions related to all of the M characterizing values are answered and the responses are recorded; integrate the answers to said M characterizing values while considering the effect of scores of certain responses on the scores of certain other responses associated with cross-related characterizing values and process said integrated answers and providing a personality report.

### BRIEF DESCRIPTION OF THE DRAWINGS

The subject matter regarded as the invention is particularly pointed out and distinctly claimed in the concluding portion of the specification. The invention, however. both as to organization and method of operation, together with objects, features, and advantages thereof, may best be understood by reference to the following detailed description when read with the accompanying drawings in which:

FIG. 1 is a schematic block diagram illustration of a system for receiving inputs from an examined person and for providing personality analysis and suitability to defined position of the person automatically, according to some embodiments of the present invention;

FIG. 2A is a schematic diagram of a process for constructing a set of personality features for presenting to an examinee, according to some embodiments of the present invention:

FIG. 2B is a schematic illustration of graphical representation result of examinee assessment, indicative of the extent of presence of personal characteristics in the examinee, according to some embodiments of the present invention;

FIG. 3 is schematic flow diagram of the process of presenting a set of features to an examinee, receiving his response and recoding it, and analyzing and providing characteristic scales of the examinee, according to some embodiments of the present invention; and

FIG. 4 is a flow diagram presenting method of utilizing characteristics scale of an examinee resulting from the process depicted in FIG. 3 to assess suitability of the examinee to a specific position, according to embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, unless specifically stated otherwise, as apparent from the following discussions, it is appreciated that discussions utilizing terms such as, for example, “processing,” “computing,” “calculating,” “determining,” “establishing”, “analyzing”, allocating, “checking”, “receiving”, “selecting”, “comparing”, “reporting”, “recording”, “detecting”, “prompting”, “storing” or the like, refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

As used herein, the term “storage unit” may refer to any apparatus, device, system and/or array of devices that is configured to store data, for example, video recordings. The storage unit may include a mass storage device, for example Secure Digital (SD) cards, an optical storage device such as a CD, a DVD, or a laser disk; a magnetic storage device such as a tape, a hard disk, Redundant Array of Independent Disks (RAID). Direct-Attached Storage (DAS). Storage Area Network (SAN), a Network Attached Storage (NAS), or the like. Each of the storage units may include the ability to write data to the storage and read the data from the storage unit for further use, e.g., video files may be read from the storage unit, upon a request, for example, when an investigation of an incident is required.

The storage units may be physically located in the organization facility(ies). for example, a plurality of hard disks physically located in the IT storage room, or may be available to the organization via a network connection, for example, Storage Area Network (SAN) or Network Attached Storage (NAS).

In order to ease the burden involved in responding to a long list of questions, and further in order to minimize the undesired biasing of personality analysis involved in system where the examinee/candidate is requested to respond by according a grade to his/her answer from a scale of grades, questionnaires prepared according to some embodiments of the present invention include only challenges requiring the examinee to respond by YES or NO. The challenge is in the form of a word representing situation/feature with respect to which the examinee is requested to respond with YES if the situation/feature embodied in the presented word, hereinafter feature_term, accords/fits him/her or NO if not. The inventor of the invention embodiments of which are described below has discovered that high correlation of analyses performed based on this method exists with respect to the examinee's personality, skills and suitableness of the candidate to a defined position, compared with known methods, yet with much shorter time required for answering the questionnaire and with lower statistical variances.

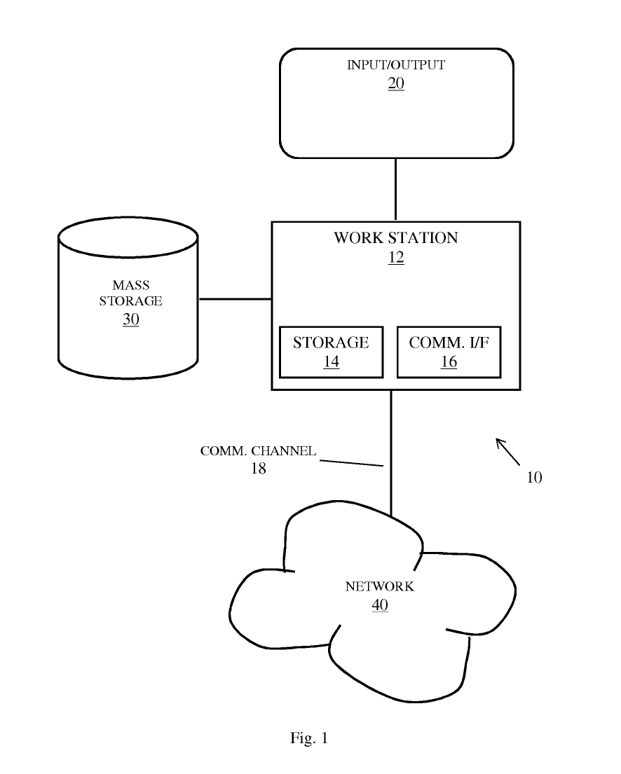

Reference is made to FIG. 1, which is a schematic block diagram illustration of system 10 for receiving inputs from an examined person and for providing personality analysis and suitability to defined position of the person automatically, according to some embodiments of the present invention. System 10 comprises work station 12, input/output means 20, storage means 30 and communication means 16 for communicating with other computational resources and optionally with other users via network 40 over communication channel(s). Work station 12 may be any computer such as desk top, lap top, tablet, smartphone and the like, which enables performing executable code and communicating with input/output (I/O) means 20 and may be in active communication with storage means 14 and communication means 16. Storage means 14 may be any non-transitory storage device or means known in the art, adapted to store software programs such as operating system (OS) and dedicated programs enabling system 10 to perform the method according to some embodiments of the present invention. According to some embodiments of the present invention, input means 20, work station 12 and mass storage 30 may all be included in a single device, either stationary or mobile.

I/O unit 20 may comprise display means such as a screen or similar means and input means such keyboard (actual and/or virtual), pointing device such as mouth (wired/wireless) or the like, touch screen and the like, as is known in the art—means that are adapted to allow a user, such as an examinee, to enter data and/or to respond to prompts made by the executed program(s). I/O means 20 may also include, according to some embodiments, audible I/O means such as microphone and/or speaker/earphones via which the executed program(s) may provide stimulus, such as a question or a feature_term and receive responses from the user. Work station 12 may further be in an active communication with mass storage means 30 for providing data to and for receiving data from the storage. Mass storage means 30 may be embodied by any mass storage technology known in the art. Mass storage means 30 may be used for storing data received and/or processed during an analysis session of an examinee and/or for receiving data usable for conducting the personality analysis. Such data stored in mass storage means 30 and/or received from it may be.

Workstation 12 may communicate with, additional resources and/or other users and/or other mass storage devices via network 40, for example the Internet, in order to send and/or receive data.

Before a personality analysis session begins, the user and or the client of the examinee's analysis may define parameters for the analysis. For example, the user he/she may define employment suitability by terms of the definition of the intended job and/or parameters defining that job. However, it will be noted that parameters and processes used for automatically analyzing the personality features of the examinee according to some embodiments of the present invention may not be defined or tuned by the user. These parameters and processes are solely administered by program(s) executed during the personality examination and reporting. In some embodiments, a supervisor of system 10 may be allowed to interfere with the automatic process by way of adjusting or setting values to specific parameters used in the personality analysis process. The stored code in storage 14 may include software programs that may tune, re-tune and change the parameters used for analyzing personality features based on one or more of the following: averaging of metadata representing histograms of similar features collected and compared from large number of examinees, results of a certain examination, for example, when an examinee repeats an answer to question or a feature_term which he/she previously answered, and the like.

When personality analysis and job suitability are to be performed, an examinee may activate the relevant program executed (or remotely accessed) at workstation 12.

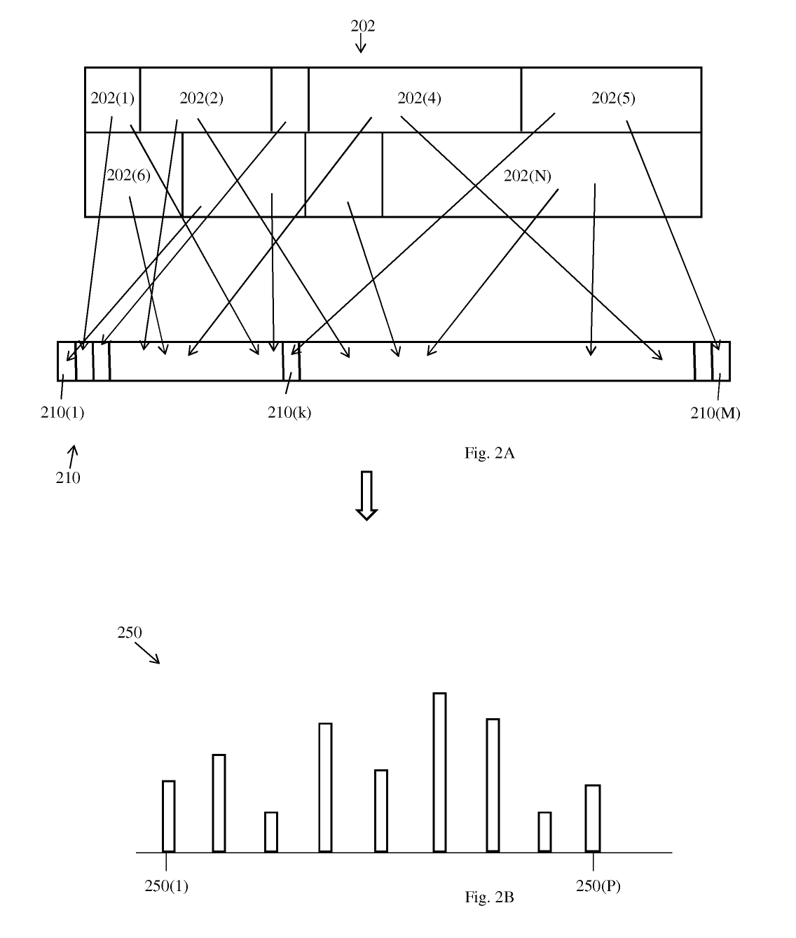

Prior to the beginning of actual personality analysis session, the examinee may be requested to feed certain personal data items such as name, ID number, age, gender, present occupation and position, etc. Once the required initial personal data of the examinee has been entered and fed to system 10, a set of feature_terms is prepared. Reference is made to FIG. 2A, which is a schematic diagram of a process for constructing a set of personality features (feature_terms) for presenting to an examinee, according to some embodiments of the present invention. As presented in FIG. 2A, a large set, or collection, 202 of feature_terms may be stored in a storage such as storage 14. Large set 202 is not exposed to an examinee. Large set 202 may be partitioned into sub-sets 202(1), 202(2) . . . 202(N), each comprising of personality characterizing features of a certain type of features. System 10 may construct a set of feature_terms 210 which is unique for the examinee at a certain personality examination session. The set 210 may include at least one feature_term from each sub-set. The number of feature_terms selected from each sub-set. their order of appearance in set 210 and their order with respect to each other is uniquely selected by the respective computer program stored in storage 14 and executed by work station 12. The number M of feature_terms included in a uniquely constructed set 210 may vary according to some embodiments of the present invention and may be, in some embodiments, equal to 90. The number of analyzed personality characters may vary and may be, according to some embodiments of the present invention, equal to 9. Uniquely constructed set 210 is aimed to be presented to the examinee, one feature_term at a time, as will be explained in details below. The construction of set 210 may automatically be influenced by certain parameters, such as the personality characteristics that need to be analyzed with respect to the examinee, the job or position for which the suitability of examinee is being assessed. etc. In some embodiments, the specific feature_terms selected to be included in set 210 may be automatically determined based on the ability to evaluate existence and magnitude of certain personality characteristic based on the existence and magnitude of other, related, personality characteristics.

The personality characteristics that are being analyzed and accorded to the examinee, each with its specific magnitude, are based on various personality disorders known in psychology which were converted, according to some embodiments of the present invention, into normative description of nine (9) personality character types which are unique to the analysis performed according to some embodiments of the present invention. The personality types are accorded the following denominations: Scientist, CEO, Entrepreneur, Actor, Artist, Leader, Poet, Philosopher and Educator. These denominations are metaphoric and represent conversion of personality disorder into normative types. These types of personality are used to represent the personality of the examinee, by according to each of the types a numeric value ranging between zero (0) to ten (10). The numeric value is automatically extracted based on the number of positive/negative responses to feature_terms in each personality type and further based on characteristics that may be inferred from inter-relations between different types of feature_terms, according to the number of positive/negative response recorded for each of them.

Further, according to some embodiments of the present invention, the program controlling the examination automatically integrates and constructs a single personality vector, based on inter-weighing of the various personality types and their specific magnitude. The single personality vector represents a collage of characters, each according to its magnitude, as ranked by the results extracted from the series of responses of the examinee. Certain features included in the single personality vector are inferred based on inter-relations between two or more of the personality types. The construction of the single personality vector is performed using a unique algorithm, where known psychological personality examinations fail to provide automatic and computerized construction of a single personality vector.

The constructed single personality vector may further be translated to a written psychological diagnosis that may refer to a large number personality items, such as General evaluation, Honesty and trustworthy. Motivation and diligence, Organizing and management ability, Human relations, Negotiation skills. Working under pressure and persistency, Responsiveness to tasks, Analysis ability and professionalism, Advantages and disadvantages and Summary and Recommendations. The written psychological diagnosis may be produced automatically using pre-prepared and pre-stored text segments and constructing the written psychological diagnosis by using these pre-stored text segments according to the specifics of the constructed single personality vector. According to some embodiments, the written psychological diagnosis may be based on translation of the values constructing the personality vector into twenty five (25) different occupations: however, the personality vector may be translated into more than 25 occupations. The translation of the personality into these 25 different occupations is known in the art as a tool for providing written diagnosis, but automatic translation of the personality vector into these occupations was not disclosed before. This translation assigns an expected grade of suitability of the examinee to perform each of these 25 different occupations and specifically automatic grade of suitability to hold managing position—one of the most complicated predictions.

According to yet additional embodiments of the present invention, the personality analysis may provide additional personal services, such as machine—produced professional orientation consultation, machine—produced career development coaching, machine—produced consultation for development of management skills and machine—produced psychological consultation aimed to reduce several kinds of mental distresses. Further, this analysis may provide spouse matching consultation in at least two different aspects. One—for an examinee—what are the personal characteristics in a spouse that may match his/her personality, and second if two spouses respond to the examination—a report may be produced indicating the fields/characteristics in each of them that may match fields/characteristics in the other.

According to yet additional embodiments of the present invention, the personality vector may automatically be used to produce personal distresses disorders report indicating the existence of one or more of the following types of personal disorder types: Indolence—typical in a lazy person, Paranoid—typical in an integrative personality, Cyclotimic—typical in impulsive personality, Avoidant—typical in a rational personality, Schyzoid—typical in an autistic personality, Narcissism, Obsessive-Compulsive—typical in a reformatory personality, Borderline—typical in a neurotic personality and Hysterionic—typical in an adolescence personality.

As explained above, the analysis of the responses of the examinee to the set of feature_terms presented to him/her may lead to issuance of an automatically prepared report of personality characteristics that may be presented in a graphical representation as depicted in FIG. 2B in which bar graph 250 comprise of graphs 250(1) to 250(P), in which each bar represents one personality characteristic and the relative/absolute height of the bar may represent the magnitude of that characteristic in the context of the other personality characteristics. The number of presented personality characteristics P may vary and may be, according to an embodiment of the invention, equal to 9.

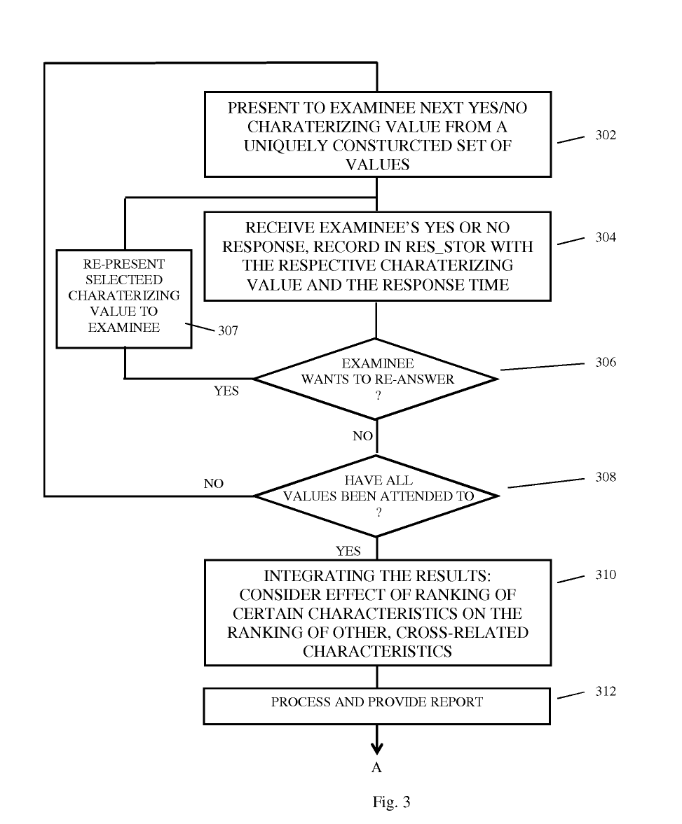

Reference is made now to FIG. 3, which is schematic flow diagram of the process of presenting a set of feature_terms, such as set 210, to an examinee, receiving his response and recoding it, and analyzing and providing characteristic scales of the examinee. according to some embodiments of the present invention. When the personality assessment session commences one feature_term from the uniquely constructed set of feature_terms is presented to the examinee, for example by means of I/O means 20 (block 302). As explained above the examinee is expected to respond by signaling to system 10 whether the presented feature_term properly describe him/her or fits him/her. The response entered by the examinee, for example using I/O means 20, is recorded by system 10 in association with the respective feature_term along with the time measured between the time the feature_term was presented to the examinee and the time he/she responded (block 304).

At any time during the personality inquiry session, the examinee may select a feature_term (such as feature_term 210(x)) that was previously presented to him/her and re-consider his/her response (decision block 306). If the examinee selected to re-address a previously presented feature_term, that feature_term is presented to him/her (block 307), and the examinee's response along with the associated feature_term, the response time, the fact that it is a re-answered feature_term and the number of times this feature_term was re-answered are recorded (block 304). If/when the examinee waives the option to re-address a previously presented feature_term (decision block 308), and in case not all of the feature_terms in feature_terms set 210 have been presented to the examinee's reference (decision block 308), the process returns to block 304 and another feature_term is presented to the examinee. In case all of the feature_terms were presented and referred to by the examinee, an integration process takes place in which all of the information gathered during the inquiry session is automatically evaluated, weighed and integrated (block 310) to provide a personality report, for example in the form of a set of scaled representations of personal characteristics of the examinee, such as scale 250 (block 312).

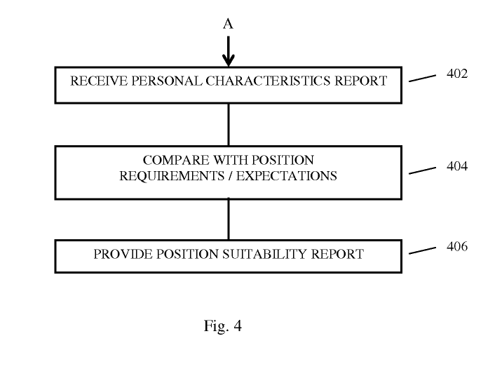

Reference is made now to FIG. 4, which is a flow diagram presenting method of utilizing characteristics scale of an examinee resulting from the process depicted in FIG. 3 to assess suitability of the examinee to a specific position, according to some embodiments of the present invention. In case there is a need to evaluate the suitability of the examinee to a specific position or job, the report issued in the process described above, for example with respect to block 312, the results may be processed, for example by means of another program or by another portion of the program used in the previously described process. The analyzed personality characteristics may be received (block 402), compared with the characteristics of the specified position/job (or those definitions may otherwise be considered) (block 404) and the comparison or consideration may yield position suitability of the examinee to the specified position/job (block 406).

As described above, the several benefits of methods and systems operative in accordance with embodiments of the present invention comprise:
Personality analysis is received as a result of the analysis of a single set of responses from the examinee/candidate, as opposed to methods and tests known in the art which require several examinations/tests (up to 20 tests).
The analysis that is performed according to some embodiments of the present invention includes automated integration of the results and automated translation of the analyzed results into:
   a basis for the personality report, while tests known in the art require human intervention in integrating the results and in providing a report;
   report on the management skills of the examinee, while methods known in the art require in person interviews by a group of experts;
   Report on the leadership ability of the examinee, while tests known in the art do not provide report on leadership ability;
   Report on mental disorders of the examinee/candidate as their effect influences the suitability of the candidate to the proposed position. Tests known in the art do not provide report of the mental disorders this way, but rather provide a general mixed evaluation of the mental disorders or psychopathological report that has no contribution with regard to the candidacy of the examinee:
   Report that forecasts the moral personality of the candidate based on his/her personality characteristics, while other tests either do not provide such forecast of focus on estimating the moral response of the candidate in view of defined challenges;
   Automated written report of the personality of the candidate that includes description of ten (10) different psychological functioning of the examinee/candidate which includes assignment of 28 different scalable personal characteristics to these 10 different psychological functioning. These 28 scalable personal characteristics may have one of the values ‘low’, ‘average’ or ‘high’.
   Report that maps the 9 different personality characters (for example the bars of graph 250 (Fig. B)) to a 9×9 matrix of 81 characteristic types, where each type is formed by the fused values of two of the characters types at the location of the cross of the which the characteristic type is found;
   Report that is based on core-features, where each personality comprises all of the core-features, in certain magnitude of each of them;
   Report that provides general employment suitability (that is not directed only to the job for which the candidate was evaluated);
   Report on mate match that may be directed to a given spouse who also took the exam, or may provide list of characteristics of a spouse that will match the character of the examinee/candidate;
   Report that describe the consumer profile of the examinee and his/her tendency to be a frequent complaining consumer and the expected reliability of his/her complaints:
   Coaching sessions, based on the personality analysis, that are directed to promote the candidate's career, and his/her management skills.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for automatically analyzing personality, the method comprising:
(a) presenting to an examinee a Yes/No type question related to a characterizing value, said characterizing value is selected from a set of N characterizing values formed uniquely for the examinee;
(b) receiving from said examinee a Yes or No response;
(c) recording said response with its respective characterizing value:
(d) allowing said examinee to re-answer said question when said examinee wishes to re-answer said question;
(e) repeating steps (a) (d) until questions related to all of the M characterizing values are answered and the responses are recorded:
(f) integrating the answers to said M characterizing values while considering the effect of scores of certain responses on the scores of certain other responses associated with cross-related characterizing values; and
(g) processing said integrated answers and providing a personality report.

2. The method of claim 1 wherein the value of M is 90.

3. The method of claim 1 wherein said examinee's Yes or No response indicates whether the characterizing value presented to the examinee characterizes the examinee.

4. The method of claim 1 wherein said step of recording comprises recording of the time period lapsing from the minute the characterizing value was presented to the examinee and the time the examinee has provided an answer.

5. The method of claim 1 wherein said step of recording comprises recording how many times the examinee responded to that characterizing value question.

6. The method of claim 1 wherein said set of M characterizing values is formed uniquely for the examinee based on a pre-exam session in which said examinee responds to personal characterizing inquiry.

7. The method of claim 2 further comprising:
comparing said personality report to a employment position requirements and to personal employment expectations list of said examinee; and
providing employment suitability score of said examinee for said employment position.

8. The method of claim 2 further comprising:
calculating and presenting a graph indicative of the relative of strength of each of P personal characteristics of said examinee with respect to each other.

9. The method of claim 1 wherein said set of M characterizing values is formed from characterizing values taken from N sets of characterizing values, each of said sets of characterizing values includes characterizing values of the same character type.

10. The method of claim 9 wherein said characterizing values from said N sets are entered into said set of M characterizing values in a random order.

11. A system for automatically analyzing personality comprising:
a workstation comprising:
a storage unit; and
a communication interface for rambling communication between the workstation, a mass storage unit, and a large area network,
a mass storage unit for storing large collections of characterizing values and data representing crowd averages;
a large area network; and
an input/output unit for presenting instructions, data and questions to an examinee and for receiving input indications from said examinee, wherein said workstation is configured to:
(a) present to an examinee a Yes/No type question related to a characterizing value, said characterizing value is selected from a set of N characterizing values formed uniquely for the examinee:
(b) receive from said examinee a Yes or No response;
(c) record said response with its respective characterizing value;
(d) allow said examinee to re-answer said question when said examinee wishes to re-answer said question;
(e) repeat steps (a)-(d) until questions related to all of the M characterizing values are answered and the responses are recorded;
(f) integrate the answers to said M characterizing values while considering of scores of certain responses on the scores of certain other responses associated with cross-related characterizing values; and
(g) process said integrated answers and providing a personality report.

12. The system of claim 11 wherein said workstation is further configured to:
compare said personality report to a employment position requirements and to personal employment expectations list of said examinee; and
provide employment suitability score of said examinee for said employment position.

13. The system of claim 11 wherein said step of recording comprises recording of the time period lapsing from the minute the characterizing value was presented to the examinee and the time the examinee has provided an answer.

14. The system of claim 11 wherein said step of recording comprises recording how many times the examinee responded to that characterizing value question.

15. The system of claim 11 wherein said set of M characterizing values is formed uniquely for the examinee based on a pre-exam session in which said examinee responds to personal characterizing inquiry.
